(19) United States
(12) Patent Application Publication
(10) Pub. No.: US 2008/0089495 A1
(43) Pub. Date: Apr. 17, 2008

(54) METHOD AND SYSTEM FOR REMOTELY ACCESSING A DATA ARCHIVE VIA A TELEPHONE

(76) Inventors: Scot MacLellan, Roma (IT); Ivan Orlandi, Rome (IT)

Correspondence Address: IBM CORPORATION;INTELLECTUAL PROPERTY LAW, 11400 BURNET ROAD, AUSTIN, TX, 78758, US

(21) Appl. No.: 11/870,713

(22) Filed: Oct. 11, 2007

(30) Foreign Application Priority Data
Oct. 11, 2006 (EP) 06122130.5

(51) Int. Cl. H04M 11/00; G10L 15/04

(52) U.S. Cl. 379/93.25; 704/251; 704/258; 704/E15.005; 704/E13.002

(57) ABSTRACT

A method, system and computer product for accessing, by means of a telephone, a database containing data arranged in at least one table including a plurality of table entries, each table entry including a plurality of information elements. The invention retrieves identifiers of the information elements from the table. Each of the retrieved identifiers of the information elements are associated with a choice key, wherein the choice keys are adapted to be input by a user through a telephone. The invention presents, through the telephone, the identifiers of the information elements together with the respective choice keys to a user. Once a choice key input by the user is received through the telephone, the invention retrieves data from the table using the input choice key, wherein said retrieved data includes the content of the information element in at least one table entry whose identifier corresponds to the input choice key. The retrieved data is presented to the user through the telephone.

### TECHNICAL FIELD

The present invention relates generally to the field of data processing and data processing systems. Specifically, the invention concerns a method, and a related system, for enabling remote access to a data archive, like for example a defect management system archive, a problem management system archives a change management system archive, via a telephone or similar telecommunication device.

### BACKGROUND ART

Defect management is an important part of a software product development project, and generally consists in the elimination of bugs or other problems.

Defect management systems are an important tool for software development and verification engineers in the management of the software development project.

A defect management system is adapted to record and track defects of the software product being developed, and the progress towards their resolution.

An example of commercially-available products that implement defect management systems are the “Rational Clearcase” and the “Rational Clearquest” products sold by IBM corporation.

To facilitate the resolution of the underlying problems, the development and verification engineers insert and exploit detailed information, like a description of the problems, symptoms, how to recreate the situation that caused the problems, etc. On the contrary, other users, like the project managers, usually do not need such a highly detailed information as the development and verification engineers, rather they tend to use higher-level, summary information, like the number of open defects, their status, and their severity or priority; occasionally, they may require more detailed information, for example to track the progress towards resolution of a particularly critical defect, possibly because such a defect is blocking test execution, or because a critical milestone date (e.g., a release to the market) is looming.

Monitoring the overall state of a software development project through known defect management systems requires the use of a computer: the users of the defect management system have to be in their workplace, or at best, if they happen to be located in a remote place, such as at home or in a hotel, they have to be connected to the system over the Internet.

### SUMMARY OF THE INVENTION

The Applicant has observed that known defect management systems are not completely satisfactory.

In particular, the fact that the defect management system can be accessed only by means of a computer may be a serious limitation to the usefulness of the tool, since it may be not practical or in some cases even impossible to access the data when it is necessary. For example, at critical points in a software development project a project manager may wish to frequently check the project state, but it may not be possible to do this if, for example, he/she is not at the workplace, or is in a place where Internet access is not possible or practical, or if he/she is traveling, etc.

The Applicant has found that these limitations can be greatly reduced if access to the defect management system archive, at least to summary data, is enabled from a telephone (either wired or wireless), or similar telecommunication device. Indeed, availability of a telephone is far more frequent and likely than availability of a computer and a connection to the Internet.

Essentially, the present invention proposes a method, and a related system, by means of which a menu structure is dynamically built by reading the contents of a data archive (database), particularly a database having a relatively flat (i.e., tabular) structure, like the defect management system archive. The database is accessed dynamically, and the access to the database does not take place through the defect management system code; in other words, access to the database is direct, and takes place without invoking any of the application code of, e.g., the defect management system; therefore, the access to the database is independent of any of the assumptions made when constructing the defect management system application code; a hierarchy of menus is built that is structured in a form suitable to be navigated by means of such a simple telecommunication device like a telephone.

According to an aspect of the present invention, a method as set forth in the appended claim 1 is provided. In particular, a method of accessing by means of a telephone a database is provided, wherein said database contains data, for example related to problems of software products being developed, arranged in at least one table including a plurality of table entries, each table entry including a plurality of information elements, the method comprising:
a) retrieving from the table identifiers of said information elements (for example, querying the table to retrieve table column names);
b) associating to each of the retrieved identifiers of the information elements a choice key, wherein said choice keys are adapted to be input by a user through a telephone;
c) presenting through the telephone to a user said identifiers of the information elements in association with the respective choice keys;
d) receiving a choice key input by the user through the telephone;
e) retrieving data from the table exploiting the input choice key, wherein said retrieving data includes retrieving the content of the information element in at least one table entry whose identifier corresponds to the inputted choice key; and
f) presenting the retrieved data to the user through the telephone.

In particular, in case in step e) two or more table entries are identified, and the contents of the information elements that corresponds to the input choice key of the two or more table are different, the method comprises repeating steps b) to f) by associating a choice key to each of the two or more information elements. In other words, the retrieved data are presented to the user either as pure data, if the retrieved data is a single leaf node of the result set, or as a new menu, if the navigation through the data has not arrived at the leaf node.

According to another aspect of the present invention, a data processing system as set forth in the appended claim 8 is provided. A still further aspect of the present invention concerns a computer program as set forth in appended claim 9.

### BRIEF DESCRIPTION OF THE DRAWINGS

The features and advantages of the present invention will be best understood reading the following detailed description of an embodiment thereof, provided merely by way of non-limitative example, description that will be conducted making reference to the attached drawings, wherein:

FIG. 1 schematically shows a scenario wherein the present invention can be applied;

FIG. 2 schematically shows the generic structure of a data processing apparatus used in the scenario of FIG. 1;

FIG. 3 schematically shows in terms of functional blocks, intended to represent software components and/or hardware components, a structure of a system according to an embodiment of the present invention;

FIG. 4 schematically shows a portion of a table arrangement of data of a defect management system archive;

FIG. 5 is a schematic flowchart with the main steps of a method of remotely accessing the defect management system archives according to an embodiment of the present invention;

FIG. 6 shows in greater detail, and still in terms of functional blocks that are intended to represent software components and/or hardware components, a structure of a dynamic menu structure builder component of the system of FIG. 3, according to an embodiment of the present invention; and

FIG. 7 shows pictorially a process of building menu structures from the table of FIG. 4, according to an embodiment of the present invention.

### DETAILED DESCRIPTION OF THE PREFERRED EMBODIMENT(S)

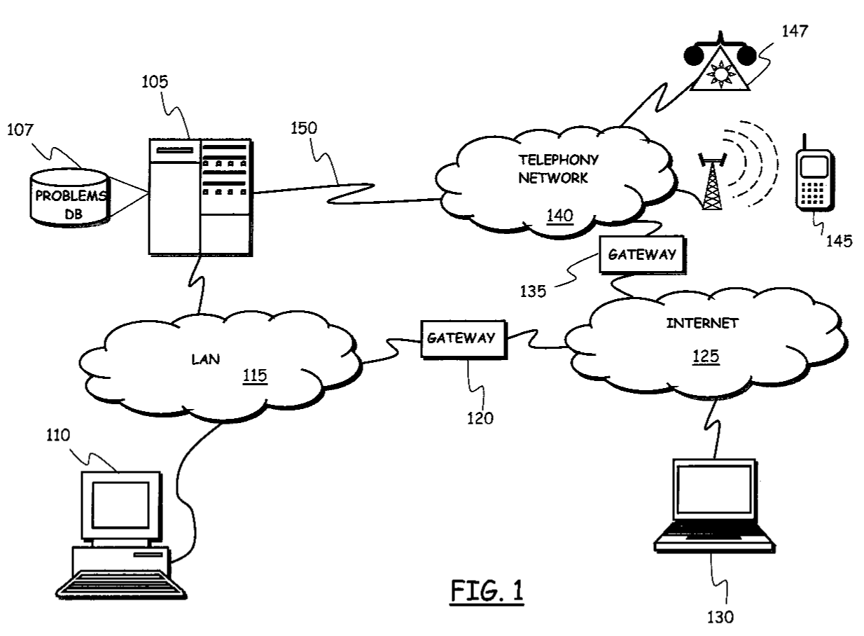

With reference to the drawings, in FIG. 1 an exemplary scenario is schematically shown where the present invention can be applied; in particular, the exemplary scenario that will be considered relates to a defect management system. Reference numeral 105 denotes a data processing apparatus, for example a server computer, where a (server component of a) defect management system is resident. The defect management system is used by, e.g., software development and verification engineers working to software development projects for the management of the projects they are working on; the defect management system is adapted to record and track defects in software products being developed, and the progress towards their resolution. For example, the development and verification engineers access the defect management system by connecting to the server 105 using their Personal Computers (PCs) 110 (where a client component of the defect management system is resident), which are connected to the server computer 105 through a wired or wireless private network, like a Local Area Network (LAN) 115. In particular, the development and verification engineers and, in general, any one who has a computer connected, through the LAN 115, to the server computer 105, like for example a project manager, can access a database 107 (“problem database”) of the defect management system, containing detailed information about the software products being developed, defects and, in general, problems reported in respect of the software products, the progress towards their resolution, and thus monitor the state of the project.

The LAN 115 is connected, through a gateway 120, to a public network like the Internet 125. Similarly to the users of the computers 110 connected to the LAN 115, any user having a computer 130 (e.g., a notebook) with an available access to the Internet 125 (and having suitable access privileges) may get connected to the LAN 115 and, particularly, to the server computer 105, and access the database 107 of detailed information of the defect management system resident on the server computer 105, and monitor the state of the project.

The server computer 105 is also connected, through a wired or wireless telephone connection 150, to a telephony network 140 (more generally, a system of one or more interconnected telephony networks). The telephony network 140 may comprise a wired telephony network and/or a mobile telephony network; the mobile telephony network 140 may comprise in particular a mobile telephony network of the second or third generation, e.g. a GSM (Global System for Mobile communications) network, a GPRS (General Packet Radio System) network, an EDGE (Enhanced Data Rate for GSM Evolution) network, a UMTS (Universal Mobile Telecommunications System) network. The telephony network 140 may also be connected, through a gateway 135 (more generally, one or more gateways) to the Internet 125. For example, in the case of a GPRS or EDGE network, the gateway 135 may be one of the Gateway GPRS Support Nodes (GGSNs) of the GPRS infrastructure.

According to the present invention, a user having a telephone or other similar telecommunication device, like for example a mobile phone (cellular phone) or smart phone or PDA (Personal Digital Assistant) with an embedded (mobile) phone 145, or even a fixed, wired telephone 147 (supporting Dual Tone Multiple Frequency digit signals or pulsed digit signals) that can access or is connected to the telephony network 140 may access the problems database 107 of the defect management system resident on the server computer 105 containing the detailed information about the state of the software products being developed. The user of the wired telephone 147 connects to the server computer 105 exploiting the telephone connection 150 of the server computer 105 to the telephony network 140. The user of the mobile phone 145 may connect to the server computer 105 either through the telephone connection 150, and also, in case the telephone 145 supports packet switched communications, like in the case of a GPRS or EDGE phone, through the Internet 125.

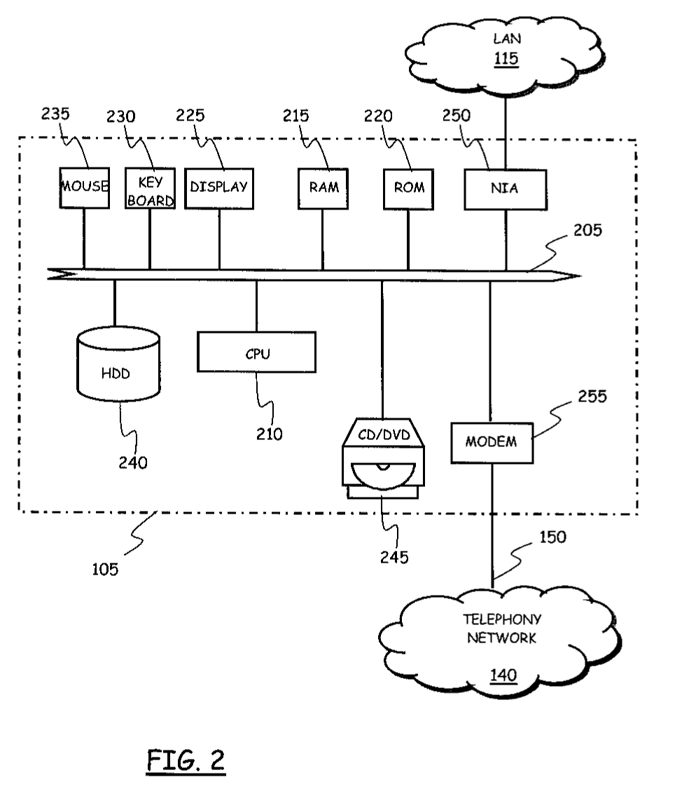

In FIG. 2, the general structure of a generic data processing apparatus, like the server computer 105, is schematically shown. Several functional units are connected in parallel to a data communication bus 205, for example of the PCI type. In particular, a Central Processing Unit (CPU) 210, typically comprising a microprocessor (the CPU may possibly comprise more than one microprocessor), controls the operation of the computer 105, a working memory 215, typically a Random Access Memory (RAM), is directly exploited by the CPU 210 for the execution of programs and for temporary storage of data, and a Read Only Memory (ROM) 220 stores a basic program for the bootstrap of the computer 105. The computer 105 comprises several peripheral units, connected to the bus 205 by means of respective interfaces. Particularly, peripheral units that allow an easy and friendly interaction with a human user are provided, such as a display device 225 (for example a CRT—Cathodic Ray Tube—, an LCD—Liquid Crystal Display—or a plasma monitor), a keyboard 230 and a pointing device 235 (for example a mouse or a touchpad). The computer 105 also includes peripheral units for local mass-storage of programs and data (e.g., operating system, application programs, user files), such as a magnetic Hard-Disk Driver (HDD) 240, driving magnetic hard disks, and a CD-ROM/DVD driver 245, for reading/writing CD-ROMs/DVDs. Other peripheral units may be present, such as a floppy-disk driver for reading/writing floppy disks, a memory card reader for reading/writing memory cards and the like. The computer 105 is further equipped with a Network Interface Adapter (NIA) 250 for the connection to the LAN 115; the computer 105 also includes a MODEM 255, for enabling the telephone connection 150 to the telephony network 140.

It is pointed out that FIG. 2 is also illustrative of the general structure of the computers 110 and 130, and, at least in its essential components (CPU, memory resources, etc.) of any apparatus having data processing capabilities, like for example the mobile phone 145, particularly in case it is a GPRS/EDGE/UMTS phone or a PDA.

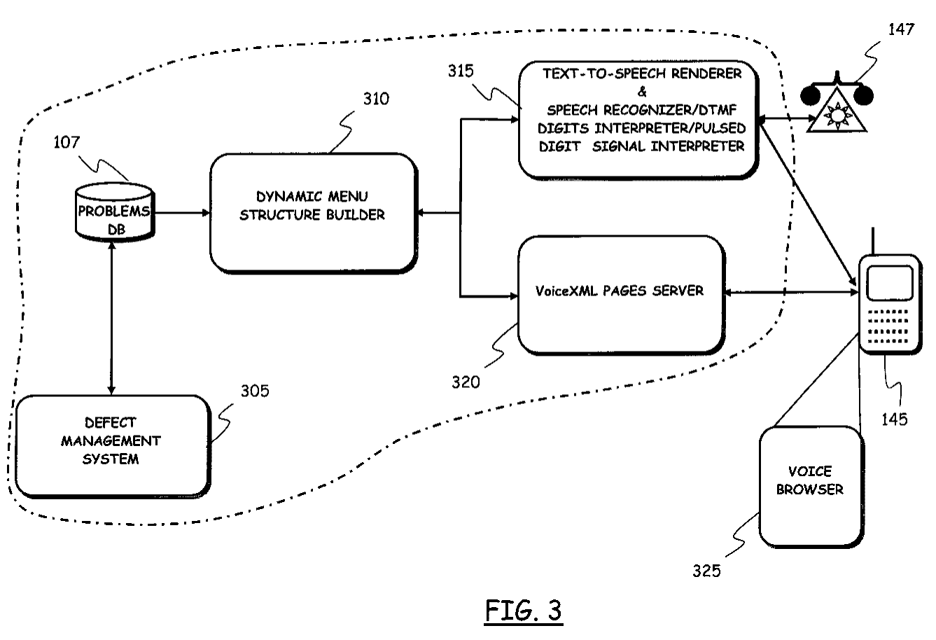

FIG. 3 schematically shows, in terms of functional blocks, the main functional components of a system according to an embodiment of the present invention adapted to allow a user to access the problems database 107 of the defect management system simply by means of a telephone. The system's functional components may be implemented totally in software/firmware, totally in hardware, partly in hardware and partly in software/firmware. Functional elements like, for example, an operating system resident on the server computer 105 are to be considered inherently present and are neither explicitly shown nor described.

In particular, in FIG. 3 the elements enclosed within the dash-and-dot line are part of the server computer 105; reference numeral 305 denotes the (server component of the) defect management system resident on the server computer 105, and that allows users like software development engineers to access the problems database 107 to report problems/defects in respect of software products being developed, report/monitor progresses towards the problems/defects resolution, and the like. When a user has available a computer, like the computer 110 and the computer 130, and a connection to the server computer 105 through the LAN 115 and the Internet 125, he/she can access the defect management system 305.

According to an embodiment of the present invention, in order to allow a user not having an available computer and/or connection to the LAN 115/the Internet 125 get information about the state of software products development projects, exploiting a telephone or other similar communication device, a dynamic menu structure builder module 310 is provided in the server computer 105, interfacing with the problems database 107, and adapted to build dynamically hierarchic menu structures, responsive to the choices of the user, as will be described in detail later on. The dynamic menu structure builder module 310 also interfaces with a module 315 adapted to implement a text-to-speech rendering, and a speech recognizer and/or a DTMF digits interpreter and/or a pulsed digit signals interpreter, for the interaction with the user via the phone 145 or 147; in particular, the module 315, fed with a menu structure dynamically built by the module 310, is adapted to vocally render menu options to the user, by means of text-to-speech rendering, and to receive user's selections for navigating through the dynamic menu structure, where the user's selections may be vocal, in which case the module 315 exploits speech recognition functionalities, or in the form of DTMF or pulsed signals representative of digits of the telephone dialboard/keyboard. The module 315 is also adapted to vocally render to the user pieces of information stored in the database 107, when the user, navigating through the dynamic, hierarchic menu structure, reaches a leaf (i.e., a terminal node). The dynamic menu structure builder module 310 may also interface with a VoiceXML pages server module 320, adapted to build and publish VoiceXML pages based on the menu structure dynamically built by the module 310 and fed thereto, that can be exploited by users having available a mobile phone 145 with a resident Voice browser 325.

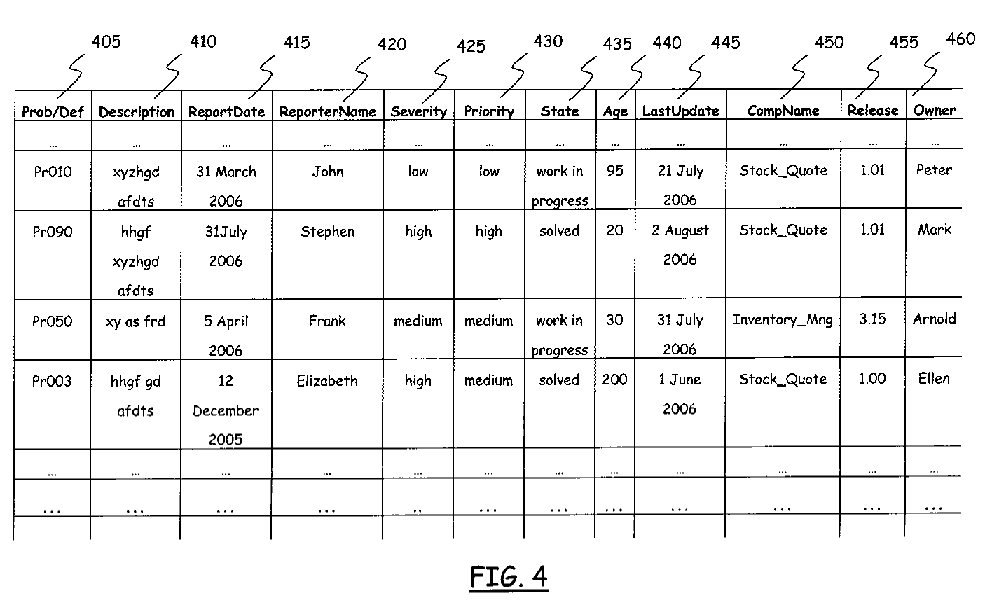

FIG. 4 schematically shows a simplified table 400 intended to represent a portion of an exemplary problems database 107. The table 400 is structured so as to include an entry (corresponding to a table row) for each reported problem/defect. The table 400 has several columns, each one having a respective label and corresponding to a field in the generic table entry, as listed below:
a first column 405, in the example labeled “Prob/Def”, relates to entry fields intended to contain an identifier of the problem/defect reported;
a second column 410, in the example labeled “Description”, relates to entry fields intended to contain a description of the reported problem/defect;
a third column 415, in the example labeled “ReportDate”, relates to entry fields intended to contain the date the problem/defect has been reported;
a fourth column 420, in the example labeled “ReporterName”, relates to entry fields intended to contain the name of the person who reported the problem/defect;
a fifth column 425, in the example labeled “Severity”, relates to entry fields intended to contain an indication (e.g., “low”, “medium”, “high”) of the severity of the problem/defect; the severity of a problem/defect is an indication of the impact of the problem/defect on the overall functionality of the software product being developed;
a sixth column 430, in the example labeled “Priority”, relates to entry fields intended to contain an indication (e.g., “low”, “medium”, “high”, “highest”) of the priority to be given to the handling and solving of the problem/defect;
a seventh column 435, labeled “State”, relates to entry fields intended to contain a description of the current state (e.g., “work in progress”, “closed”, etc.) of the problem/defect;
an eighth column 440, labeled “Age”, relates to entry fields intended to contain an indication of how long the problem/defect has been in the current state;
a ninth column 445, in the example labeled “LastUpdate”, relates to entry fields intended to contain an indication of when the last update has been made (it corresponds to the date of the last change made to that entry of the table);
a tenth column 450, in the example labeled “CompName”, relates to entry fields intended to contain an identifier of the software product, or of the component of a software product in respect of which the reported defect relates;
an eleventh column 455, in the example labeled “Release”, relates to entry fields intended to contain an identifier of the release of the (component of the) software product specified in column 450;
a twelfth column 460, in the example labeled “Owner”, relates to entry fields intended to contain an identifier of the person who is currently dealing with the problem/defect for solving it.

Preferably, the labels of the columns should be such that they are adapted to communicate concisely the nature of the content.

It is underlined that the table of FIG. 4 is merely exemplary; several additional fields may be present, and/or different fields from those exemplarily shown. Also, although defect management systems generally tend to have a problem database with a flat table structure like that presented, this is not to be construed limitatively for the present invention.

Even in cases where the data to be accessed are organized in a database having a more complicate structure, techniques such as the construction of “views” can be used to “flatten” the schema and exploit the present invention. As known in the art, in the field of relational databases, “views” are a combination of selected columns (data elements) from different tables, and are used to provide a “summary table” constructed from selected elements out of the real database tables.

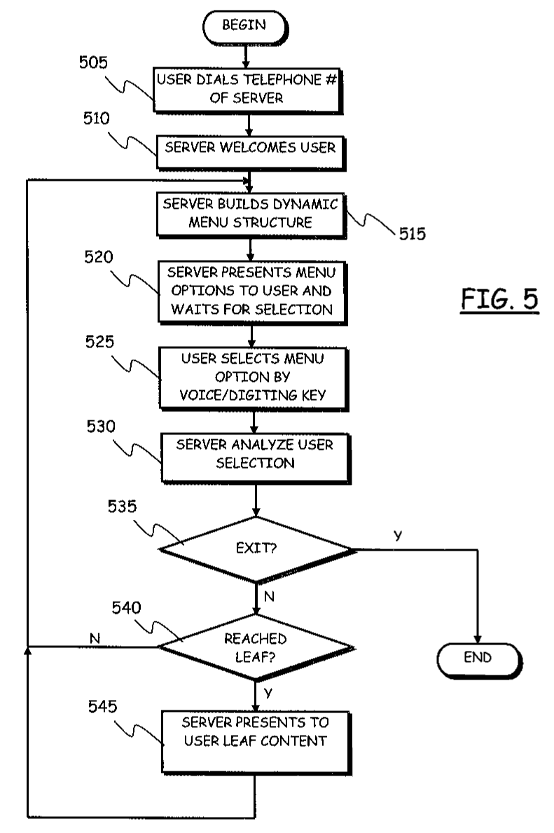

A method according to an embodiment of the present invention, by which a user, exploiting simply a phone or other similar communication apparatus, can remotely access the information contained in the problem database, is hereafter described, with the help of the schematic flowchart of FIG. 5. In particular, the description that follows relates to the case in which the server computer 105 is contacted using the telephone connection 150; the description however applies, mutates mutandis as far as the form of rendering the dynamic menu is concerned, to the case the user has a GPRS phone, and the server computer 105 is contacted through the Internet.

A user wishing to remotely access the information contained in the problems database 107 of the defect management system using his/her phone 145 or 147 dials a telephone number of the telephone connection 150 (block 505). The server computer 105 (e.g., the module 315) welcomes the user (block 510), then the dynamic menu structure builder module 310 reads the problem database 107 and builds the dynamic menu structure (block 515). The menu structure that is thus built is fed to the renderer module 315, which presents menu options to the user (block 520). For example, the menu options may be presented vocally, exploiting the text-to-speech rendering, each menu option being associated to a number, e.g. from 0 to 9, corresponding to one of the digits that the user can dial using his/her phone 145 or 147. The server computer 105 then waits for the user's selection (block 520). The user selects the desired menu option by, e.g., dialing the corresponding digit, or by pronouncing it (block 525). The dynamic menu builder module 310 analyzes the user selection (block 530): in case the user has selected to exit the system (exit branch Y of decision block 535), the communication session is terminated. The dynamic menu builder module 310 also checks whether, in the navigation through the menus presented thereto, the user has reached a leaf, i.e. a terminal point at which no more options can be associated (decision block 540): in the affirmative case (exit branch Y), the server presents to the user (e.g., vocally, using the text-to-speech renders the information content of the leaf (e.g., the state of a certain problem/defect in respect of a certain software product); in the negative case (exit branch N of decision block 540), further menu structures are dynamically built, corresponding to the possible options available at that navigation point, and presented to the user (the operation flow jumps back to block 515).

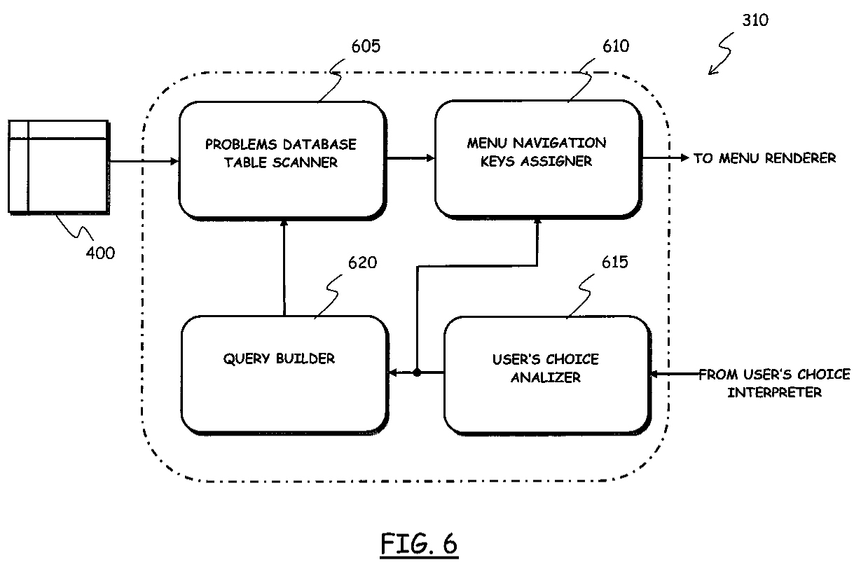

FIG. 6 schematically depicts in greater detail an exemplary functional structure of the dynamic menu structure builder module 310, in an embodiment of the present invention. A problem database table scanner module 605 is adapted to access the problem database 107 and to scan the tables forming the database, by means of queries. The problem database table scanner module 605 interfaces with a menu navigation keys assignor module 610, adapted to assign navigation keys, like for example digits from 0 to 9, to the menu items produced by the scanning of the problems database performed by the module 610. The menu items produced by the scanning, and the menu navigation keys assigned thereto, are passed to the renderer module 315. A user's choice analyzer module 615 receives from the user's choice interpreter module 315 the menu navigation key corresponding to the selection made by the user, and the determines the corresponding menu item. The information about the menu item corresponding to the user's selection is passed to a query builder module 620, that builds a query to be passed to the scanner module 605 for further dynamically building sub-menu structures. The information about the menu item corresponding to the user's selection is also passed to the menu navigation keys assignor module 610, which can exploit it to assign the navigation keys in an order that takes into account the statistics by which the various menu items are selected by the users (in other words, more frequently selected menu items may be assigned the lower digits).

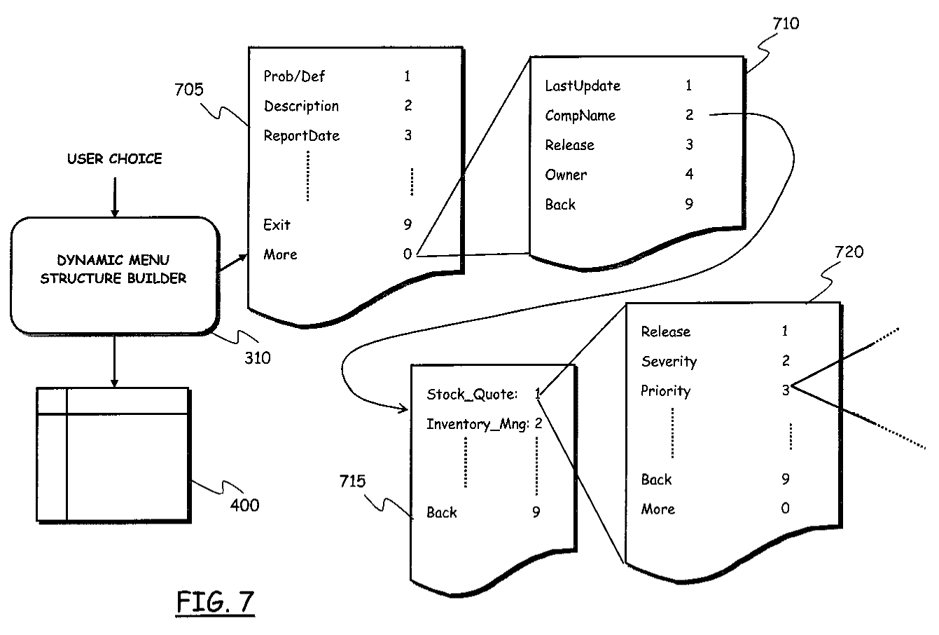

FIG. 7 pictorially shows how menu structures are dynamically created by the dynamic menu structure builder module 310 of FIG. 6, making reference to the exemplary table of problems/defects depicted in FIG. 4.

When the user, exploiting the phone 145 or 147, gets connected to the server computer 105, the scanner module 605 scans the table 107, and reads the names of the columns 405-460 thereof. The column names form the menu items that are passed to the module 610, that assigns the navigation keys to the table columns. If, as in the shown example, there are more columns than available digits, the module 610 may assign a predetermined key (e.g., the digit “0”) to a “More” menu item; an exemplary navigation key assignment (pictorially shown in FIG. 7 and denoted therein as 705) is the following:
column 405, labeled “Prob/Def”: digit “1”;
column 410, labeled “Description”: digit “2”;
column 415, labeled “ReportDate”: digit “3”;
column 420, labeled “ReporterName”: digit “4;
column 425, labeled “Severity”: digit “5”;
column 430, labeled “Priority”: digit “6;
column 435, labeled “State”: digit “7”;
column 440, labeled “Age”: digit “8”;
“exit” menu option (for quitting the system): digit “9”;
“more” menu option (for the remaining columns): digit “0”.

These menu options, with the corresponding navigation keys, are presented to the user by the renderer 315. For example, in case of text-to-speech rendering, the menu options and navigation keys may be presented to the user vocally, like “for choosing Prob/Def dial “1” [silence] for choosing Description dial “2””, etc.

If the user dials “0”, i.e., he/she wants to listen which are the further table columns, the module 610 proceeds assigning navigation keys to the subsequent menu items, i.e. the remaining table columns, like below (the assignment list is pictorially shown in FIG. 7, wherein it is denoted as 710):
column 445, labeled “LastUpdate”: digit “1”;
column 450, labeled “CompName”: digit “2”;
column 455, labeled “Release”: digit “3”;
column 460, labeled “Owner”: digit “4”;
“back” menu option (for going back to the former menu): digit “9” (no “more” menu options are presented, because there are no further menu items).

Let it be assumed that the user dials the “2” digit, for selecting the column “CompName”: the query builder module 620 builds a query to be passed to the scanner module 605, so as to retrieve, from the table 400, all the different values present in the fields of the column 450, i.e. all the different software product/component names; the different software product/component names form the menu items that are passed to the navigation key assignor module 610. The navigation key assignor module 610 assigns the navigation keys to the different software products/components, as depicted in FIG. 7 with reference numeral 715:
software product/component “Stock_Quote”: digit “1”;
software product/component “Inventory_Mng”: digit “2”;
“back” menu option (for going back to the former menu) digit “9” (in the considered example, no “more” menu option are presented, because there are no further menu items, however, should the software products/components exceed the number of available digits, a “more” menu option would be presented, as discussed above).

The user may thus select the desired software product/component name, by dialing the corresponding digit; let it be assumed that he/she selects the product/component “Stock_Quote”: this selection is used by the query builder module 620 for building a query where the name of the software product/component “Stock_Quote” is used as a filter. The scanner module 605, using the query built by the query builder module 620, will thus build a “working set” on which it will subsequently operate, said working set being a restricted set of entries of the table 400, namely those entries that have the name of the software product/component “Stock_Quote” in the field in column 450. Preferably, the table scanner module 605 may count the number of table entries that have the name of the software product/component “Stock_Quote” in the field in column 450, and the number may be presented to the user (possibly, this feature may be presented in the form of a menu item, which the user can select), in order to let him/her know how large is the working set. The table scanner module 605 scans the working set thus created, reads the names of the columns 405-460 thereof, and the column names (exception made for the column 450) are presented to the user in association with respective navigation keys, as described above (this is pictorially shown in FIG. 7, reference numeral 720); the user, by selecting a column may thus further restrict the working set. For example, the user may select the column named “Priority” (column 430 in FIG. 4). If, as in the example herein considered, there is only one defect record for the component Stock-Quote that has the priority selected, then The working set would be restricted to only one table entry. The user will be then again presented with the names of the columns (exception made for the columns 450 and 430), and, upon selection by the user of one of the columns, a leaf in the dynamic menus structure will be reached: the user will he thus presented the content of the table entry field that corresponds to the selected column. For example, if the user selects the column named “Owner”, he/she will be presented the information about the person presently dealing with the problem (Mark); if the user selects the column named “State”, he/she will know the current state of the problem/defect, and so on. In other words, when, by successive selection of table columns, the working set is restricted to a single table entry (i.e., to a single record of the problems database), the next selection of a column by the user causes the system to present the user the content of the single remaining field in that column.

According to an embodiment of the present invention, no predefined or structured path for navigation through the problems database needs to be defined: the user can take whatever route through the data that he/she wants; the dynamicity of the menu structure building allows this possibility. Nevertheless, there may be cases where some columns of the defects table are not particularly suited for navigation; for example, referring to FIG. 4, the “Description” column 410, containing free-form text descriptions of the problems/defects, is not particularly suited for navigation: each problem/defect will in general have a unique description, and choosing this column early in the navigation through the table would cause the resulting menu structure to contain many menu items (essentially, selecting this column would not allow creating a restricted working set), and each menu item, to be rendered to the user, would be a relatively long sentence or paragraph, rather than a word or short phrase. Exploiting a rule of assignment of navigation keys to the table columns that is based on the statistics of the past users' selections, it may be provided that those columns that are not particularly suited for navigation are relegated to sub-menus presented to the user only if he/she selects the “more” option. In alternative embodiments of the invention, the table scanner module 605, and/or the navigation key assignor module 610, may perform a selection among which table columns are suitable as menu options, and which not, and avoid presenting the latter to the user.

Also, in some embodiments of the invention a navigation “cache” memory may provided, so as to allow implementing, at each level in the navigation through the table, a “back to top” option, for jumping back to the top menu structure.

Thanks to the present invention, the problem database of a defect management system may be accessed remotely even without a computer and/or a connection to the Internet, simply using a phone. Availability of a connection to a telephony network is much more diffused than, for example, availability of an Internet access.

The implementation of the present invention has been described making reference to an exemplary embodiment thereof, however those skilled in the art will be able to envisage modifications to the described embodiment, as well as to devise different embodiments, without however departing from the scope of the invention as defined in the appended claims.

In particular, although in the description reference has been made to the case of a defect management system, this is not to be construed limitatively: the invention has more general applicability to all those cases where the data to be accessed are into a single table (or appropriately organized views), and navigation is possible through filters applied to the data table For example, the invention can be applied to problem management systems and change management systems (a problem management system is a system adapted to record problems experienced by end users in production environments, and explains symptoms, severity etc. of outages or other inconvenients experienced by a malfunction of a production system; change management systems are adapted to record and track intention to make changes to a production system, for example in order to apply security patches, change configuration, upgrade to new releases, etc.). Also, the applicability of the invention is not restricted to data relating to software product development projects, being instead applicable to any article of manufacture that has to be tested, whose quality has to be evaluated, and problems/defects of which have to be solved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of the present description, a computer-usable or computer-readable medium can be any apparatus, device or element that can contain, store, communicate, propagate, or transport the program for use by or in connection with the computer or instruction execution system.

The medium can be an electronic, magnetic, optical, electromagnetic, infrared, or semiconductor storage medium, network or propagation medium. Examples of a storage medium include a semiconductor memory, fixed storage disk, moveable floppy disk, magnetic tape, and an optical disk. Current examples of optical disks include compact disk-read only memory (CD-ROM), compact disk-read/write (CD-R/W) and digital versatile disk (DVD). Examples of a propagation medium include wires, optical fibers, and wireless transmission.

The invention can be applied in a data processing system having a different architecture or based on equivalent elements; each computer can have another structure or it can be replaced with any data processing entity (such as a PDA, a mobile phone, and the like).

1. A method of accessing by means of a telephone a database containing data arranged in at least one table including a plurality of table entries, each table entry including a plurality of information elements, the method comprising:
a) retrieving from the table identifiers of said information elements;
b) associating to each of the retrieved identifiers of the information elements a choice key, wherein said choice keys are adapted to be input by a user through a telephone;
c) presenting through the telephone to a user said identifiers of the information elements together with the respective choice keys;
d) receiving a choice key input by the user through the telephone;
e) retrieving data from the table exploiting the input choice key, wherein said retrieving data includes retrieving the content of the information element in at least one table entry whose identifier corresponds to the input choice key; and
f) presenting the retrieved data to the user through the telephone.

2. The method of claim 1, wherein said choice keys are symbols corresponding to the keys of a telephone dialboard.

3. The method of claim 1, wherein said choice keys are words adapted to be pronounced vocally by the user.

4. The method of claim 1, wherein said presenting the retrieved data comprises:
in case in step e) two or more table entries are identified based input choice key, and the information elements whose identifier corresponds to the inputted choice key in the two or more table entries are different in content are found, repeating steps b) to f) by associating a choice key to each of the two or more information elements.

5. The method of claim 1, wherein said presenting through the telephone includes vocally presenting the data.

6. The method of claim 1, wherein said presenting through the telephone includes visually displaying the data.

7. The method of, claim 1 wherein said database is selected from the group consisting of:
a database of a defect management system containing data related to problems of software products under development;
a problem management system;
a change management system.

8. A system for accessing by means of a telephone a database containing data arranged in at least one table including a plurality of table entries, each table entry including a plurality of information elements, the system comprising:
means for retrieving from the table identifiers of said information elements;
means for associating to each of the retrieved identifiers of the information elements a choice key, wherein said choice keys are adapted to be input by a user through a telephone;
means for presenting through the telephone to a user said identifiers of the information elements together with the respective choice keys;
means for receiving a choice key input by the user through the telephone;
means for retrieving data from the table exploiting the input choice key, wherein said retrieving data includes retrieving the content of the information element in at least one table entry whose identifier corresponds to the input choice key; and
means for presenting the retrieved data to the user through the telephone.

9. A computer program product in a computer readable medium for accessing by means of a telephone a database containing data arranged in at least one table including a plurality of information elements comprising instructions for carrying out the steps of a method when said computer program is executed on a data processing apparatus, the method comprising:
retrieving from the table identifiers of said information elements;
associating to each of the retrieved identifiers of the information elements a choice key, wherein said choice keys are adapted to be input by a user through a telephone;
presenting through the telephone to a user said identifiers of the information elements together with the respective choice keys;
receiving a choice key input by the user through the telephone;
retrieving data from the table exploiting the input choice key, wherein said retrieving data includes retrieving the content of the information element in at least one table entry whose identifier corresponds to the input choice key; and
presenting the retrieved data to the user through the telephone.
